(19) United States
(12) Patent Application Publication
(10) Pub. No.: US 2006/0092402 A1
(43) Pub. Date: May 4, 2006

(54) Laser crystal evaluating system

(75) Inventors: Yoshiaki Goto, Itabashi-ku (JP); Masayuki Momiuchi, Itabashi-ku (JP); Taizo Eno, Itabashi-ku (JP)

Correspondence Address: NIELDS & LEMACK, 176 EAST MAIN STREET, SUITE 7, WESTBORO, MA, 01581, US

(73) Assignee: Kabushiki Kaisha TOPCON

(21) Appl. No.: 11/205,340

(22) Filed: Aug. 17, 2005

(30) Foreign Application Priority Data
Nov. 1, 2004 (JP) 2004-318044

(51) Int. Cl. G01N 21/00

(52) U.S. Cl. 356/30

(57) ABSTRACT

A laser crystal evaluating system, comprising a light emitting source for emitting an excitation light, a laser crystal support base for supporting a laser crystal, a photodetection unit for receiving a laser beam emitted from the laser crystal, a moving device for relatively moving the light emitting source and the laser crystal in parallel to an end surface of the laser crystal, and an arithmetic operation control device for acquiring an amount of relative movement from the moving device and a result of photodetection from the photodetection unit, wherein a position in the end surface of the laser crystal where the excitation light enters is moved by the moving device, and the arithmetic operation control device obtains output distribution within the end surface of the laser crystal based on the incident position of the excitation light and on the result of photodetection.

### BACKGROUND OF THE INVENTION

The present invention relates to a laser crystal evaluating system for evaluating quality of a laser crystal to be used in a solid-state laser.

In a solid-state laser, an excitation light is projected to a laser crystal. Then, the excitation light is resonated by the laser crystal, and a laser beam is emitted.

Crystal quality of the laser crystal exerts influence on the quality (such as light intensity, light intensity distribution, polarization, stability, etc.) of the outputted laser beam. Also, due to micro-size flaws caused during cutting, or to residual stress or to diffraction, the laser beam emitted from the laser crystal is instable or the laser beam is not emitted when the excitation light enters peripheral portion of the laser crystal. Even when the excitation light enters the central portion, a predetermined light intensity may not be obtained or the site to emit the highest light intensity is not at the center of the incident surface. That is, there are individual differences depending on each laser crystal, and there may be variations in the quality of the laser beam emitted according to each laser crystal.

In the past, the quality of the laser crystal itself has not been evaluated. After the laser crystal is incorporated in a solid-state laser, evaluation test is performed as the solid-state laser. In this respect, performance characteristics as required may not be obtained due to the quality of the laser crystal in some cases, and this has caused the decrease in yield of the solid-state laser.

### SUMMARY OF THE INVENTION

It is an object of the present invention to provide a laser crystal evaluating system, by which it is possible to evaluate performance characteristics of a laser crystal itself, to improve yield of the solid-state laser, to detect a site where intensity of an emitted laser beam is equal to or more than a predetermined intensity, and to effectively utilize the performance characteristics of the laser crystal.

To attain the above object, the present invention provides a laser crystal evaluating system, which comprises a light emitting source for emitting an excitation light, a laser crystal support base for supporting a laser crystal, a photodetection unit for receiving a laser beam emitted from the laser crystal, a moving device for relatively moving the light emitting source and the laser crystal in parallel to an end surface of the laser crystal, and an arithmetic operation control device for acquiring an amount of relative movement from the moving device and a result of photodetection from the photodetection unit, wherein a position in the end surface of the laser crystal where the excitation light enters is moved by the moving device, and the arithmetic operation control device obtains output distribution within the end surface of the laser crystal based on the incident position of the excitation light and on the result of photodetection. Also, the present invention provides the laser crystal evaluating system as described above, wherein the arithmetic operation control device has a display unit, graphically represents the output distribution of the photodetection result to correspond relative movement, and displays the output distribution on the display unit. Further, the present invention provides the laser crystal evaluating system as described above, wherein the arithmetic operation control device has criteria for evaluation, the criteria for evaluation include at least one output value reference, an output area and a position of the area, and if the criteria are met, evaluation is performed according to the output value reference. Also, the present invention provides the laser crystal evaluating system as described above, wherein the laser crystal support base comprises a cooler to maintain the laser crystal at a predetermined temperature. Further, the present invention provides the laser crystal evaluating system as described above, wherein the laser crystal contains a laser crystal and a wavelength conversion crystal integrated with each other. Also, the present invention provides the laser crystal evaluating system as described above, wherein a polarizing plate is provided on an exit side of the laser crystal to evaluate polarizing characteristics. Further, the present invention provides the laser crystal evaluating system as described above, wherein maintaining temperature of the laser crystal is changed and temperature characteristics of the laser crystal is evaluated. Also, the present invention provides the laser crystal evaluating system as described above, wherein there is provided an optical filter which is arranged on the laser beam emitted from the laser crystal, and the optical filter allows a wavelength of a fundamental wave light to pass. Further the present invention provides the laser crystal evaluating system as described above, wherein the arithmetic operation control unit has two or more output value references, and the laser crystal is classified based on the result of photodetection. Also, the present invention provides the laser crystal evaluating system as described above, wherein the laser crystal is evaluated at two or more temperatures, and the laser crystal is classified according to the operation temperatures. Further, the present invention provides the laser crystal evaluating system as described above, wherein the laser crystal and the wavelength conversion crystal are attached with each other by adhesive agent. Also, the present invention provides the laser crystal evaluating system as described above, wherein a first dielectric reflection film is formed on an incident end surface of the laser crystal, and a second dielectric reflection film is formed on the other end surface.

The present invention provides a laser crystal evaluating system, which comprises a light emitting source for emitting an excitation light, a laser crystal support base for supporting a laser crystal, a photodetection unit for receiving a laser beam emitted from the laser crystal, a moving device for relatively moving the light emitting source and the laser crystal in parallel to an end surface of the laser crystal, and an arithmetic operation control device for acquiring an amount of relative movement from the moving device and a result of photodetection from the photodetection unit, wherein a position in the end surface of the laser crystal where the excitation light enters is moved by the moving device, and the arithmetic operation control device obtains output distribution within the end surface of the laser crystal based on the incident position of the excitation light and the result of photodetection. As a result, it is possible to identify the quality of the crystal itself in advance, and this contributes to the improvement of production yield by eliminating defects caused by the laser crystal when a diode pumped solid-state laser is produced.

According to the present invention, a laser crystal evaluating system is provided wherein the arithmetic operation control device has a display unit, graphically represents the output distribution of the photodetection result to correspond relative movement, and displays the output distribution on the display unit. Thus, the results of evaluation can be visually judged.

According to the present invention, a laser crystal evaluating system is provided wherein the arithmetic operation control device has criteria for evaluation, the criteria for evaluation include at least one output value reference, an output area and a position of the area, and if the criteria are met, evaluation is performed according to the output value reference. As a result, evaluation can be made to match each application purpose of the laser crystal, and the laser crystal can be effectively utilized.

According to the present invention, a laser crystal evaluating system is provided wherein the laser crystal support base comprises a cooler to main maintain the laser crystal at a predetermined temperature. As a result, evaluation accuracy is improved. Also, by varying temperature during the evaluation of the laser crystal, evaluation can be made to match each temperature. This makes it possible to select a laser crystal by taking the condition of use of the diode pumped solid-state laser into consideration.

According to the present invention, a laser crystal evaluating system is provided wherein the laser crystal contains a laser crystal and a wavelength conversion crystal integrated with each other. Thus, it is possible to perform overall evaluation of the laser crystal, which has been turned to form of a chip.

### BRIEF DESCRIPTION OF THE DRAWINGS

FIG. 1 is a drawing to explain basic arrangement of a diode pumped solid-state laser, to which the present invention is applied;

FIG. 2 is a schematical perspective view of an embodiment of the present invention;

FIG. 3 shows a result of evaluation by using a laser crystal evaluating system according to the embodiment of the present invention. FIG. 3 (A) is a 3-dimensional graph to show the results of evaluation of a laser crystal, and FIG. 3 (B) is a 2-dimensional graph to show the results of evaluation of the laser crystal;

FIG. 4 shows other examples of the results of evaluation by the laser crystal evaluating system of the embodiment of the present invention. FIG. 4 (A) is a 3-dimensional graph to show the results of evaluation of a laser crystal, and FIG. 4 (B) is a 2-dimensional graph to show the results of evaluation of the laser crystal;

FIG. 5 represents a flow chart of a process of evaluation in an embodiment of the present invention;

FIG. 6 is a drawing of a laser crystal chip to be evaluated by the laser crystal evaluating system of the embodiment of the present invention; and

FIG. 7 is a drawing of a laser crystal chip to be evaluated by the laser crystal evaluating system of the embodiment of the present invention.

### DETAILED DESCRIPTION OF THE PREFERRED EMBODIMENT

Description will be given below on the best mode to carry out the present invention referring to the drawings.

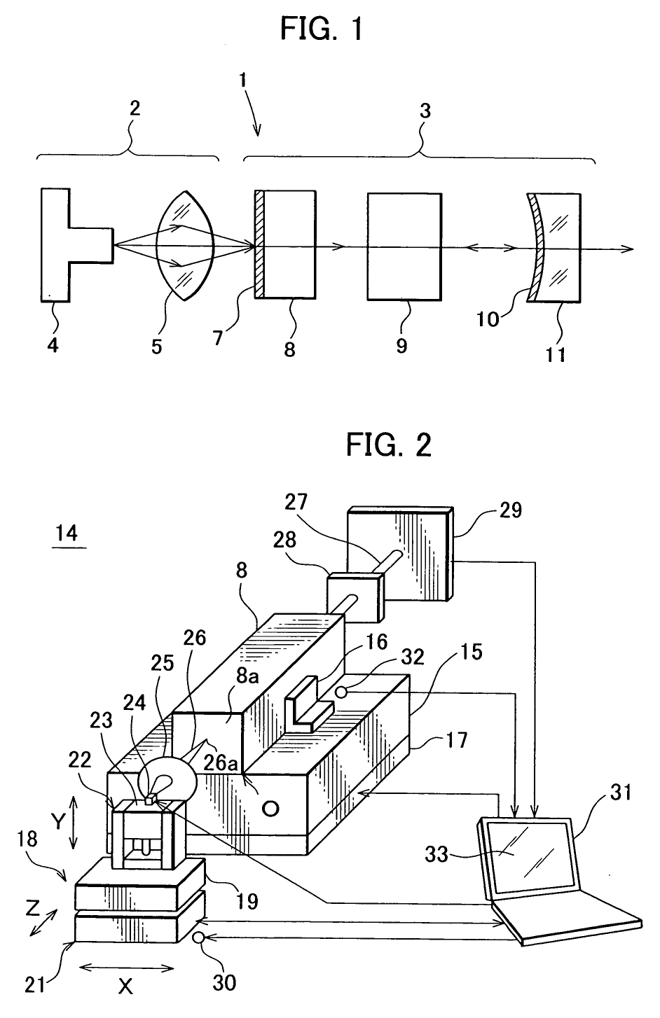

First, description will be given on a diode pumped solid-state laser 1 referring to FIG. 1.

In FIG. 1, reference numeral 2 denotes a light emitting unit, and reference numeral 3 denotes an optical resonator. The light emitting unit 2 comprises an LD light emitter 4 and a condenser lens 5. Further, the optical resonator 3 comprises a first optical crystal (laser crystal 8) with a first dielectric reflection film 7 formed thereon, a second optical crystal (nonlinear optical crystal (NLO) (wavelength conversion crystal 9)), and a concave mirror 11 with a second dielectric reflection film 10 formed thereon. At the optical resonator 3, a laser beam is pumped, resonated and amplified, and a wavelength is converted and the laser beam is outputted.

In the diode pumped solid-state laser 1, the LD light emitter 4, which emits a semiconductor laser, is used as an excitation light source for projecting an excitation light to the optical resonator 3, for instance.

The laser crystal 8 converts the excitation light to a fundamental wave and amplifies the light. As the laser crystal 8, Nd:YVO₄ with an oscillation line of 1064 nm is used. Or, YAG (yttrium aluminum garnet) doped with Nd³+ ions is used. YAG has oscillation lines of 946 nm, 1064 nm, 1319 nm, etc. Also, Ti (sapphire) with oscillation lines of 700-900 nm may be used.

The wavelength conversion crystal 9 performs wavelength conversion to turn the fundamental wave to ½. As the wavelength conversion crystal 9, KTP (KTiOPO₄; titanyl potassium phosphate) is used.

On a side of the laser crystal 8 closer to the LD light emitter 4, the first dielectric reflection film 7 is formed. The first dielectric reflection film 7 is highly transmissive to the laser beam from the LD light emitter 4, and the first dielectric reflection film 7 is highly reflective to an oscillation wavelength (fundamental wavelength) of the laser crystal 8. The first dielectric reflection film 7 may be highly reflective to secondary higher harmonic wave or second harmonic generation (SHG). Naturally, for the second harmonic generation, the first dielectric reflection film 7 may be provided on an end surface of the laser crystal 8 opposite to the excitation side or on an excitation side of the wavelength conversion crystal 9.

The concave mirror 11 is arranged to face the laser crystal 8. A face of the concave mirror 11 closer to the laser crystal 8 is worked out in form of a concave spherical face with an adequate radius, and the second dielectric reflection film 10 is formed on the concave spherical face. The second dielectric reflection film 10 is highly reflective to the fundamental wavelength and the second dielectric reflection film 10 is highly transmissive to the second harmonic generation.

As described above, when the first dielectric reflection film 7 of the laser crystal 8 is combined with the second dielectric reflection film 10 of the concave mirror 11 and an excitation light from the LD light emitter 4 is pumped to the laser crystal 8 via the condenser lens 5, the light runs reciprocally between the first dielectric reflection film 7 of the laser crystal 8 and the second dielectric reflection film 10. Because the light can be confined for long time, it is possible to resonate and amplify the light.

The wavelength conversion crystal 9 is placed within the optical resonator 3, which comprises the first dielectric reflection film 7 of the laser crystal 8 and the concave mirror 11. When a strong coherent light such as a laser beam enters the wavelength conversion crystal 9, the secondary higher harmonic wave is generated, which doubles a frequency of the light. The generation of the secondary higher harmonic wave is called “second harmonic generation”. Thus, from the diode pumped solid-state laser 1, a laser beam with a wavelength of 532 nm is emitted, for instance.

When wavelength conversion is not required for the laser beam projected from the diode pumped solid-state laser 1, the wavelength conversion crystal 9 is removed from the arrangement shown in FIG. 1. In this case, the second dielectric reflection film 10 allows several % of the fundamental wave to pass. The condenser lens 5 may not be used. In such case, a distance between the LD light emitter 4 and the laser crystal 8 may be shortened.

The laser crystal 8 used in the diode pumped solid-state laser 1 determines quality of the laser beam emitted from the diode pumped solid-state laser 1. Some of the manufactured laser crystals 8 may not emit a laser beam of required quality. Also, a central portion of an incident end surface of the laser crystal 8 does not necessarily emit a laser beam of the highest quality such as the highest intensity.

In order to evaluate quality of the laser crystal 8, the laser crystal evaluating system described below inspects whether the laser crystal 8 emits a laser beam of predetermined quality and inspects oscillating condition of the laser beam corresponding to an incident position of an excitation light 12 (described later) at an incident surface of the laser crystal 8, and investigates distribution of intensity of the oscillated laser beam.

Referring to FIG. 2, description will be given on a laser crystal evaluating system 14.

On a laser crystal support base 15, the laser crystal 8 is removably mounted by using a fixing means 16 as required. The laser crystal support base 15 comprises a cooler 17 such as thermoelectric cooling element (TEC), and the laser crystal 8 can be cooled down by the cooler 17. The laser crystal 8 to be evaluated may be a single body or the laser crystal 8 may be provided with a first dielectric reflection film 7 and a second dielectric reflection film 10 formed on end surfaces respectively.

A triaxial moving unit 18 is provided so as to face an incident end surface 8a side of the laser crystal 8. The triaxial moving unit 18 comprises an X-Z-axes moving unit 21 for moving an X-Z-axes stage 19 in two directions of X-axis and Z-axis, a Y-axis moving unit 22 provided on the X-Z-axes stage 19, and a Y-axis stage 23 to be moved in a Y-axis direction by the Y-axis moving unit 22. On the Y-axis stage 23, a light emitting source 24 for emitting an excitation light such as LD is arranged.

On an exit side of the light emitting source 24, a condenser lens 25 is mounted on the Y-axis stage 23. An excitation light 26 emitted from the light source 24 is converged and is projected to the laser crystal 8.

The excitation light 26 is oscillated by the laser crystal 8, and a laser beam of fundamental wave (hereinafter referred as “fundamental wave light 27”) is projected from the laser crystal 8.

On an exit end surface side of the laser crystal 8, an optical filter 28 allowing a wavelength of the fundamental wave light 27 to pass is provided. Further, a photodetection unit 29 is provided on a transmission side of the optical filter 28. As the photodetection unit 29, PD (photodiode), CCD (charge coupled device), etc. may be used. As the optical filter 28, a filter is used, which cuts off unnecessary light and to allow only the light to be evaluated to pass.

It is designed in such manner that the X-Z-axes moving unit 21 and the Y-axis moving unit 22 are driven and controlled by an arithmetic operation control unit 31, e.g. a personal computer. Moving position can be determined in directions of X-axis, Y-axis and Z-axis from a reference point O (origin of the coordinate). An amount of movement in each of the directions of 3 axes is detected by a position detector 30 respectively, and the result of the detection is sent to the arithmetic operation control unit 31.

The reference point O is determined by installing the laser crystal 8 on the laser crystal support base 15. For instance, the laser crystal 8 is pressed against the fixing means 16, and the reference point O is determined by the fixing means 16. For instance, the reference point O is defined as a point formed at a site where a vertical plane, in which the laser crystal 8 is abutted to the fixing means 16, crosses a horizontal plane, in which the laser crystal 8 is abutted to the laser crystal support base 15. In FIG. 2, a right lower corner of the incident end surface of the laser crystal 8 is defined as the reference point O.

For instance, when the reference point O is determined as a point where the vertical plane, in which the laser crystal 8 is abutted to the fixing means 16, crosses the horizontal plane, in which the laser crystal 8 is abutted to the laser crystal support base 15, the reproducibility of the position of the reference point O is ensured even when the laser crystal 8 is replaced.

It is so designed that the cooler 17 is driven according to a control signal from the arithmetic operation control unit 31. Temperature of the laser crystal 8 is detected by a temperature sensor 32. The result of the detection is fed back to the arithmetic operation control unit 31, and cooling temperature of the laser crystal 8 is controlled.

From the photodetection unit 29, a photodetection signal depending on the photodetecting condition is sent to the arithmetic operation control unit 31. At the arithmetic operation control unit 31, the position of the light emitting source 24 is associated with the photodetection signal from the photodetection unit 29, and the result is recorded.

Now, description will be given on operation.

The laser crystal 8 is installed on the laser crystal support base 15. The X-Z-axes moving unit 21 and the Y-axis moving unit 22 are driven by the arithmetic operation control unit 31, and the X-Z-axes stage 19 and the Y-axis stage 23 are restored to the reference point.

The light emitting source 24 is driven and the excitation light 26 is emitted. The excitation light 26 may be a continuous light or a pulsed light.

By driving the X-Z-axes moving unit 21, the X-Z-axes stage 19 is moved in the direction of Z-axis, and exit condition of the excitation light 26 is adjusted. Next, by driving the X-Z-axes moving unit 21, the X-Z-axes stage 19 is moved in the direction of X-axis (+), and an incident point 26a of the excitation light 26 on the incident end surface 8a is moved in the direction of X-axis (+). With the movement of the incident point 26a, a photodetection signal from the photodetection unit 29 is sent to the arithmetic operation control unit 31 at a predetermined pitching. An amount of displacement from the reference point O is detected by the position detector 30, and the detection result is sent to the arithmetic operation control unit 31. By the arithmetic operation control unit 31, position data from the position detector 30 of the triaxial moving unit 18 is associated with the photodetection signal, and the data is stored. The movement of the X-Z-axes stage 19 may be performed by pitch feeding or by continuous feeding.

When the incident point 26a is moved over the entire width in the direction of X-axis of the laser crystal 8, the Y-axis moving unit 22 is driven, and the incident point 26a is moved in the direction of Y-axis by a predetermined pitch. By driving the X-Z-axes moving unit 21, the X-Z-axes stage 19 is moved in the direction of X-axis (−) . Then, the position data from the position detector 30 is associated with the photodetection signal from the photodetection unit 29, and the data is stored. The range of scanning may be limited only to the central portion when necessary.

When the movement is made over the entire X-axis width of the laser crystal 8 in the direction of X-axis (−), the Y-axis stage 23 is driven, and the Y-axis moving unit 22 is driven. The incident point 26a is moved again in the direction of Y-axis by a predetermined pitch. The X-Z-axes stage 19 is moved in the X-axis (+) direction by the X-Z-axes moving unit 21. Then, the position data from the position detector 30 is associated with the photodetection signal from the photodetection unit 29, and the data is stored in the same manner as the above.

Through cooperative operation of the movement of the incident point 26a in the X-axis direction over the entire width of the laser crystal 8 by the driving of the X-Z-axes moving unit 21 and stepwise feeding in the Y-axis direction by the driving of the Y-axis moving unit 22, the incident point 26a of the excitation light 26 is moved and scans over the entire surface of the incident end surface 8a. Then, the photodetection signal over the entire surface of the incident end surface 8a and the position signal associated with the photodetection signal are acquired.

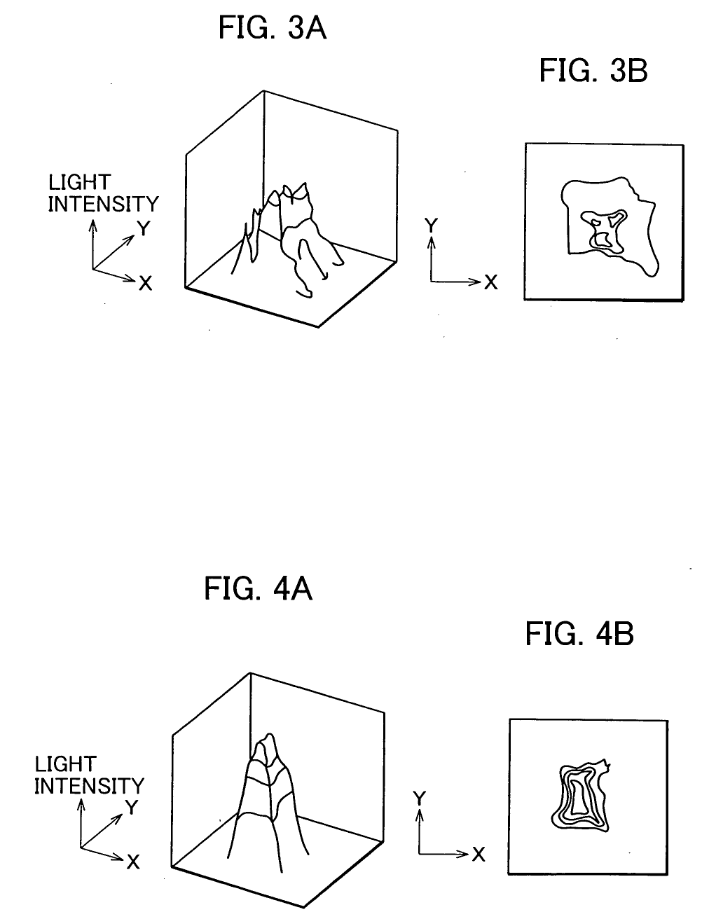

Based on the data of the incident position of the excitation light 26 on the incident end surface 8a and based on the data of the photodetection signal corresponding to the incident position (light intensity of the fundamental wave light 27 emitted from the laser crystal 8), the arithmetic operation control unit 31 prepares a 3-dimensional distribution graph of light intensity as shown in FIG. 3 (A) or in FIG. 4 (A), and the light intensity distribution is displayed on a display unit 33 of the arithmetic operation control unit 31. In FIG. 3 (A) and FIG. 4 (A), the symbol X-Y respectively represents coordinate in the incident end surface of the laser crystal 8, and the symbol Z represents output intensity of the photodetection unit 29. Also, a 2-dimensional light intensity distribution graph as shown in FIG. 3 (B) or in FIG. 4 (B) is prepared, and the graph is displayed on the display unit 33. In FIG. 3 (B) and in FIG. 4 (B), each of the symbols X-Y represents coordinate in the incident end surface of the laser crystal 8, and contour lines in the figure show output intensities of the photodetection unit 29.

By 3-dimensional display, oscillation characteristics of the laser crystal 8 can be visually judged. Further, by using different colors to match different intensities, the value of light intensity of the emitted fundamental wave light 27 can be easily identified. In case of 2-dimensional display, the distribution of light intensity is shown by contour lines or by display of different colors. Thus, it can be easily identified whether the contour lines or the colors showing the predetermined light intensity is spreading over the predetermined area or not, or the position of the area can be easily identified. This contributes to the accurate evaluation of whether the product is acceptable or defective.

For instance, when evaluation result shown in FIG. 3 is compared with the evaluation result shown in FIG. 4, the light intensity is high at the central portion in the evaluation result shown in FIG. 4. Also, the area is large and wide and there is no recess on the top portion. Thus, the laser crystal 8 evaluated in FIG. 4 is determined as an acceptable product compared with laser crystal 8 evaluated in FIG. 3.

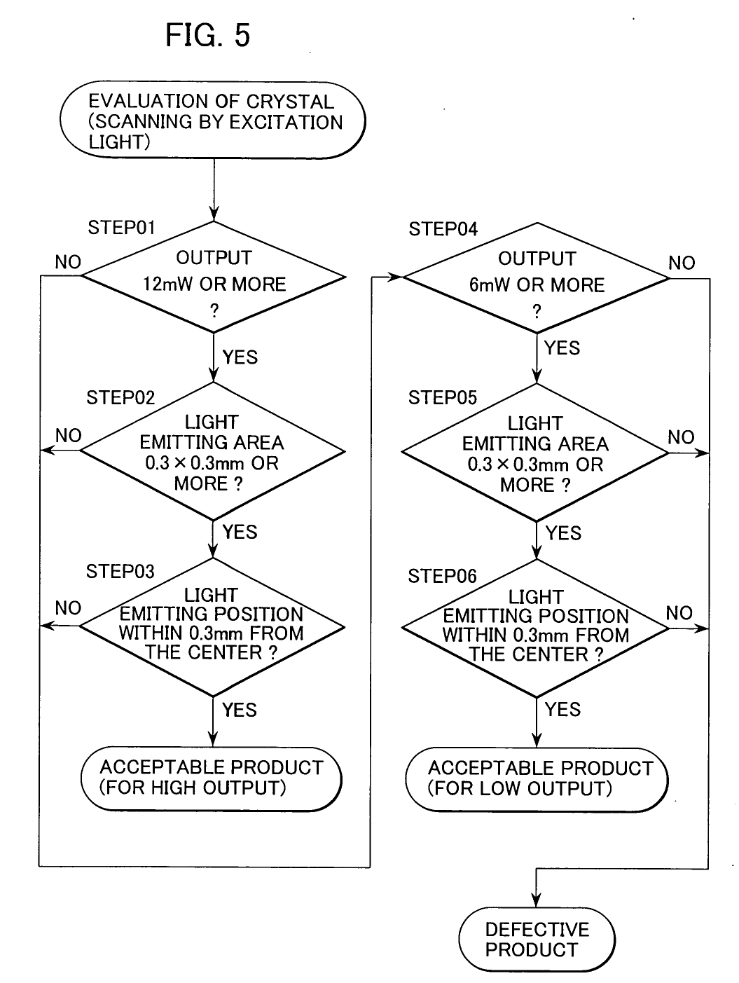

Next, referring to FIG. 5, description will be given on a case where evaluation is made whether the laser crystal 8 is acceptable or defective by the arithmetic operation control unit 31.

Criteria for determining whether the product is acceptable or defective are as follows: whether the light intensity acquired by the laser crystal evaluating system 14 (i.e. output of the photodetection signal from the photodetection unit 29) is equal to or higher than the predetermined light intensity or not; whether the area with the light intensity equal to or higher than the predetermined light intensity is equal to or larger than the range (area) as predetermined; whether the area is in adequate shape or not such that the area is not divided. Regarding the light intensity, it is judged whether an output to match the light intensity required for the laser crystal 8 has been obtained or not.

For instance, when the laser crystal 8 is installed on the laser crystal support base 15, judgment is made based on the data of the incident position of the excitation light 26 on the incident end surface 8a and on the data of the photodetection signal corresponding to the incident position. It is judged whether the output of the photodetection signal from the photodetection unit 29 is equal to or more than a first reference level, e.g. equal to or more than 12 mW (Step 01).

When the output is 12 mW, it is judged whether or not the light emitting area is equal to or larger than a predetermined area, e.g. 0.3×0.3 mm (Step 02). If the light emitting area is 0.3×0.3 mm or more, it is further judged whether or not the position of the light emitting area (e.g. the center of gravity of the graphical form) is within 0.3 mm from the center of the incident end surface 8a (Step 03).

In case it is judged that the position of the light emitting area is within 0.3 mm from the center of the incident end surface 8a in Step 03, it is evaluated that the laser crystal 8 under evaluation is an acceptable product for high output.

In case the light emitting area is found to be less than 0.3×0.3 mm in Step 02 or in case the position of the light emitting area is deviated by more than 0.3 mm from the center of the incident end surface 8a, and if the output is lower than 12 mW in Step 01, it is further judged whether it is equal to or more than the second reference level, e.g. it is equal to or more than 6 mW (Step 04). In case the output is 6 mW or more, it is judged in Step 05 whether the light emitting area is equal to or more than 0.3×0.3 mm, and it is further judged in Step 06 whether the position of the light emitting area is within 0.3 mm from the center of the incident end surface 8a or not. If the light emitting area is equal to or more than 0.3×0.3 mm and the position of the light emitting area is within 0.3 mm from the center of the incident end surface 8a, the laser crystal 8 is evaluated as an acceptable product for low output.

The laser crystal 8 not satisfying the criteria in Steps 04, 05 and 06 is evaluated as a defective product. The reference level may be divided to 3 stages and the product may be evaluated as an acceptable product for high output, an acceptable product for medium output, and an acceptable product for low output.

In the above, as the criteria for evaluation, explanation has been given on the output, the light emitting area and the position of the light emitting area, while the change of output in association with the temperature of the laser crystal 8 may be included in the criteria. In general, the condition of the output of the laser crystal 8 varies according to the temperature of the laser crystal 8, and temperature may be used as a parameter. During the evaluation by the laser crystal evaluating system 14, the laser crystal 8 may be maintained at a constant temperature by using the arithmetic operation control unit 31 and the laser crystal 8 may be evaluated at two or more temperature values, and the laser crystal may be classified to a laser crystal 8 for high temperature and a laser crystal 8 for low temperature.

Further, by using a polarizing plate as the optical filter 28, it is possible to evaluate 2-dimensional distribution of the polarizing characteristics.

Also, the laser crystal evaluating system 14 may be designed in such manner that the laser crystal support base 15 is moved in triaxial directions by fixing the light emitting source 24.

In addition to the laser crystal 8 itself, the laser crystal evaluating system 14 can evaluate a diode pumped solid-state laser 1, which has the first dielectric reflection film 7 and the second dielectric reflection film 10 directly formed on the end surfaces of the laser crystal 8 and in which the optical resonator 3 is turned to form of a chip.

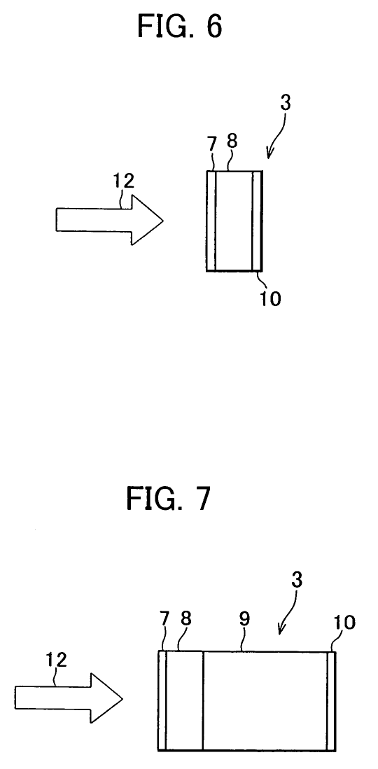

Referring to FIG. 6, description will be given on the optical resonator 3, in which the first dielectric reflection film 7, the laser crystal 8, and the second dielectric reflection film 10 are integrated and which is turned to form of a chip.

A first dielectric reflection film 7 is formed on an end surface of the laser crystal 8 such as Nd:YVO₄ or Nd:YAG where the excitation light 12 enters. A second dielectric reflection film 10 is formed on the other end surface of the laser crystal 8. The first dielectric reflection film 7 is highly transmissive to the excitation light 12, and the first dielectric reflection film 7 is highly reflective to an oscillation wave (fundamental wave) of the laser crystal 8. The second dielectric reflection film 10 is highly transmissive to the oscillation wave, and the laser crystal 8 serves as the optical resonator 3.

When the optical resonator 3 is evaluated by the laser crystal evaluating system 14, overall performance characteristics can be evaluated including parallelism of both end surfaces of the laser crystal 8 and performance characteristics of the first dielectric reflection film 7 and the second dielectric reflection film 10.

A wavelength conversion crystal 9 is attached on the laser crystal 8 by using adhesive agent, and an optical resonator 3 with a wavelength conversion function can be produced in form of a chip. This is illustrated in FIG. 7. The first dielectric reflection film 7 is formed on an incident end surface of the laser crystal 8, and the second dielectric reflection film 10 is formed on an exit end surface of the wavelength conversion crystal 9. The optical resonator 3 can also be evaluated by the laser crystal evaluating system 14 in similar manner. In this case, overall performance characteristics can be evaluated including the evaluation of the first dielectric reflection film 7, the wavelength conversion crystal 9, and the second dielectric reflection film 10, and also including the evaluation of the adhesive agent and adhesive condition between the wavelength conversion crystal 9 and the laser crystal 8.

What is claimed is:

1. A laser crystal evaluating system, comprising a light emitting source for emitting an excitation light, a laser crystal support base for supporting a laser crystal, a photodetection unit for receiving a laser beam emitted from the laser crystal, a moving device for relatively moving said light emitting source and the laser crystal in parallel to an end surface of the laser crystal, and an arithmetic operation control device for acquiring an amount of relative movement from said moving device and a result of photodetection from said photodetection unit, wherein a position in the end surface of the laser crystal where the excitation light enters is moved by said moving device, and said arithmetic operation control device obtains output distribution within the end surface of the laser crystal based on the incident position of the excitation light and on the result of photodetection.

2. A laser crystal evaluating system according to claim 1, wherein said arithmetic operation control device has a display unit, graphically represents the output distribution of the photodetection result to correspond relative movement, and displays the output distribution on said display unit.

3. A laser crystal evaluating system according to claim 1, wherein said arithmetic operation control device has criteria for evaluation, said criteria for evaluation include at least one output value reference, an output area and a position of the area, and if the criteria are met, evaluation is performed according to said output value reference.

4. A laser crystal evaluating system according to claim 1, wherein said laser crystal support base comprises a cooler to maintain the laser crystal at a predetermined temperature.

5. A laser crystal evaluating system according to claim 1, wherein the laser crystal contains a laser crystal and a wavelength conversion crystal integrated with each other.

6. A laser crystal evaluating system according to claim 1, wherein a polarizing plate is provided on an exit side of the laser crystal to evaluate polarizing characteristics.

7. A laser crystal evaluating system according to claim 4, wherein maintaining temperature of the laser crystal is changed and temperature characteristics of the laser crystal is evaluated.

8. A laser crystal evaluating system according to claim 1, wherein there is provided an optical filter which is arranged on the laser beam emitted from said laser crystal, and said optical filter allows a wavelength of a fundamental wave light to pass.

9. A laser crystal evaluating system according to claim 3, wherein said arithmetic operation control unit has two or more output value references, and the laser crystal is classified based on the result of photodetection.

10. A laser crystal evaluating system according to claim 7, wherein the laser crystal is evaluated at two or more temperatures, and the laser crystal is classified according to the operation temperatures.

11. A laser crystal evaluating system according to claim 5, wherein said laser crystal and said wavelength conversion crystal are attached with each other by adhesive agent.

12. A laser crystal evaluating system according to claim 1 or 5 or 11, wherein a first dielectric reflection film is formed on an incident end surface of said laser crystal, and a second dielectric reflection film is formed on the other end surface.
